(19) United States
(12) Patent Application Publication
(10) Pub. No.: US 2009/0236805 A1
(43) Pub. Date: Sep. 24, 2009

(54) GAUGE GUARD FOR SANITARY PIPING SYSTEM

(75) Inventor: Paul Robert Dupont, Andover, NJ (US)

Correspondence Address: HOWARD R. POPPER & ASSOC, 4436 E. CAMELBACK ROAD STE #35, PHOENIX, AZ, 85018, US

(73) Assignee: Rubber Fab Gasket and Molding, Inc.., Andover, NJ (US)

(21) Appl. No.: 12/110,483

(22) Filed: Apr. 28, 2008

Related U.S. Application Data
(60) Provisional application No. 61/038,465, filed on Mar. 21, 2008.

(51) Int. Cl. F16L 17/06

(52) U.S. Cl. 277/609

(57) ABSTRACT

An elastomeric gasket for protecting the sensing diaphragm of a sanitary piping system pressure gauge, the gasket comprising a retaining cuff and first and second flat ring portions, the gauge flange being fittable between the cuff and the first flat ring portion, the second flat ring portion being axially spaced apart from the first flat ring portion, and a protective screen retained between the axially space apart flat rings.

### CROSS-REFERENCE TO RELATED APPLICATION

This application claims the benefit of priority arising from Provisional Application Ser. No. 61/038,465 filed Mar. 21, 2008, the disclosure of which is incorporated herein by reference.

### BACKGROUND OF THE INVENTION

1. Field of the Invention

This invention relates to sanitary piping systems and, more particularly, to protecting the expensive pressure gauges used to monitor such systems as well as maintaining the sanitary integrity of such systems in the event a gauge diaphragm ruptures.

2. Description of the Related Art

Sanitary piping systems are designed with flanged couplings having O-ring seals that may be comprised of various polymeric and elastomeric materials. Among the materials conventionally employed are natural rubber, butyl rubber (a copolymer of isobutylene and isoprene, styrene-butadiene rubber (a copolymer of polystyrene and polybutadiene), nitrile rubber (a copolymer of polybutadiene and acrylonitrile, buna N rubbers, EPM (ethylene propylene rubber, a copolymer of polyethylene and polypropylene) and EPDM rubber (ethylene propylenediene rubber, a terpolymer of polyethylene, polypropylene and a diene-component), fluoroelastomers, ethylene-vinyl acetate, etc.

Periodically, sanitary piping systems are subjected to pressurized steam cleaning while at other times they may be subjected to lower than ambient pressure. When heated by the steam, the pipes expand, putting more compression on the gaskets. When cooled, the pipes contract and relax the compression of the gasket material. When the flanges are made up, the seals are compressed and the polymer chains become aligned. When the chains are aligned and packed the rubber molecules are arranged in a more crystal-like array, and give off heat. When the compression is relaxed, the polymer molecules break out of the crystal arrangement and absorb heat. The long polymer chains cross-link during curing. The elasticity is derived from the ability of the long chains to reconfigure themselves to distribute an applied stress. The covalent cross-linkages allow the elastomer to return to its original configuration when the stress is removed.

The processing of the fluid stream carried by the sanitary piping system often requires that the internal system pressure be monitored. Sanitary gauges are of many types but have in common a sanitary flange face containing a thin metallic diaphragm that is exposed to the fluid stream. The diaphragm is connected to a fluid-filled bourdon tube which flexes under the pressure inparted to it by the metallic diaphragm to drive an indicator needle across a pressure-indicating scale. Unfortunately, the metallic diaphragm can be dented or ruptured by rough handling when the sanitary piping system is taken down for cleaning. In addition, it would be desirable to safeguard the integrity of the process fluid stream from contamination should the gauge fluid leak through a defective metal diaphragm.

### SUMMARY OF THE INVENTION

In accordance with the principles of the present invention, in one illustrative embodiment thereof, a sanitary gauge protection shield is provided which comprises a substantially rigid, perforated metallic screen disposed within an elastomeric gasket having a cuff that fits over the flange of the sanitary gauge. The rigid screen prevents inadvertent touching of the thin metallic diaphragm of the gauge when the gauge is disconnected from the sanitary piping system.

In accordance with another aspect of the foregoing embodiment, a portion of the elastomeric cuff includes a tether for securing the gauge protection shield to the gauge. When the gauge is operatively connected to the sanitary piping system, the cuff may be removed from the flange of the sanitary gauge to directly expose its metallic diaphragm to the fluid pressure within the piping system while the tether maintains the cuff in proximity to the gauge in the event the gauge is later disconnected from the piping system.

In accordance with a further aspect of the embodiment, should the maintenance personnel inadvertently connect the gauge to the sanitary piping system while the gauge protection shield remains attached, the screen is provided with an array of perforations adequate in number and aperture size to permit the gauge to register the fluid pressure in the sanitary piping system.

In accordance with a still further aspect of an illustrative embodiment the elastomeric cuff of the shield includes flat surfaces for providing a fluid seal should the gauge be connected to a sanitary piping system with the cuff disposed about the flange of the sanitary gauge.

In accordance with another embodiment of the present invention, the flat surfaces of the elastomeric cuff may include a bead to form an O-ring seal.

In accordance with another embodiment of the present invention, the elastomeric cuff may include a thin flexible membrane disposed across the lumen of the piping system to isolate the sanitary piping system from the fluids employed within the gauge in the event the integrity of the gauge is breached.

### BRIEF DESCRIPTION OF DRAWING

The foregoing and other aspects and features of the present invention will become more apparent from a reading of the ensuing specification together with the drawing, in which:

FIG. 1 is a cross-sectional view of an illustrative embodiment of the invention having an elastomeric cuff and protective shield installed on a sanitary pressure gauge when the gauge is not connected to a sanitary piping system;

FIG. 2 is an end view of the cuff and protective shield of the invention;

FIG. 3 is an enlarged cross-sectional view of the protective gasket of the invention illustrating the perforated plate of the protective shield;

FIG. 4 shows a cross-sectional view of a first further embodiment of the gauge protector having an isolation membrane disposed outboard of the perforated screen;

FIG. 5 shows a cross-sectional view of a second further embodiment of the gauge protector having an isolation membrane disposed inboard of the perforated screen;

### DETAILED DESCRIPTION

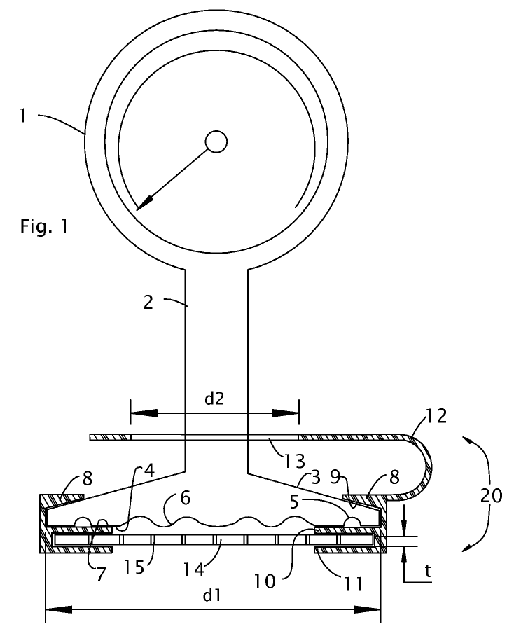

Referring to FIG. 1, a conventional pressure gauge 1 is shown having a neck portion 2 and a flange 3 for coupling to a mating flange (not shown) of a sanitary piping system. The mating flanges of a sanitary piping system are connected using a clamp (not shown) of the general type illustrated in Zimmerly U.S. Pat. No. 4,568,115.

Pressure gauge flange 3 includes flat portions 4 and an undercut portion 5 for accommodating an O-ring seal (not shown). Between the innermost flat portions 4 of flange 3, a thin, metallic, pressure-sensing diaphragm 6 is disposed. Diaphragm 6 is sensitively connected to the internal pressure sensing mechanism (not shown) of gauge 1 so as to enable the gauge to register the applied pressure by driving the gauge needle along the arcuate scale of the gauge. The internal pressure sensing mechanism of some gauges may include an operational fluid (not shown). Diaphragm 6 may easily be damaged by rough handling that may occur when the gauge is being connected or disconnected from the piping system for routine maintenance and cleaning.

An illustrative embodiment of a protective gasket 30 according to the invention is made of stretchable elastomeric material. Gasket 30 includes a circumferential cuff 8 having an internal diameter d1 dimensioned to be snuggly fittable about the periphery of flange 3 of gauge 1. An internal surface 9 of cuff 8 is advantageously tapered to conform to the tapered surface of flange 3.

Gasket 30 includes a first and a second retaining ring 10, 11. The first retaining ring 10 has a flat surface 7 that corresponds to the flat surface 4 of flange 3 that is located radially outward of diaphragm 6. The flat surface 7 of gasket 30 is disposed to lie against the flat face 4 of flange 3. An inner surface of the first retaining ring 10 and an inner surface of the second ring 11 fixedly hold protective screen 14 so that when the cuff 8 of gasket 30 is fitted on flange 3 protective screen 14 is disposed in front of diaphragm 6. The elastomeric material of which rings 10, 11 is made is advantageously desired to be sufficiently flexible so screen 14 may be removed for periodic cleaning or autoclaving as necessary.

Screen 14 is advantageously fabricated of stiff metal such as 316L stainless steel that is non-reactive with the process fluid stream of the sanitary piping system. Screen 14 has a sufficient thickness, t, so that it will not bend when cuff 8 is fitted over flange 3. When fitted to gauge 1, gasket 30 protects diaphragm from being contacted by extraneous objects or fingers.

Gasket 30 advantageously includes a tethering collar 12 having an aperture 1 3 sufficiently large enough to stretchably pass over the diameter d1 of gauge flange 3 so as to secure gasket 30 to the neck portion 2 of gauge 1. When gauge 1 is operatively connected to a sanitary piping system, it is ordinarily desired that cuff 8 be removed from flange 3. However the purpose of tethering collar 12 is to keep gasket 30 immediately at hand together with gauge 1 so that when the gauge is disengaged from the sanitary piping system the cuff 8 of gasket 30 may again be fitted to flange 3 and thereby provide continuous protection for diaphragm 6.

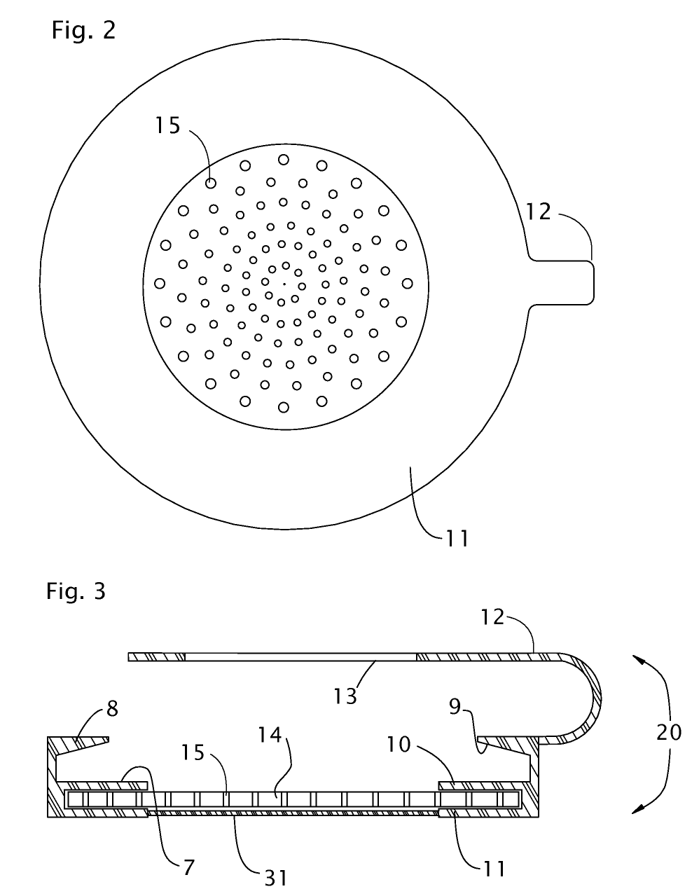

Referring to FIG. 2, an end view of gasket 30 is shown in which screen 14 is enshrouded by ring 11. A plurality of perforations 15 are provided each having a diameter small enough to prevent a finger, tool or other foreign object, such a lug wrench, screwdriver or spanner, from coming into contact with and possibly injuring diaphragm 6 of the pressure gauge.

It was mentioned above that it is ordinarily desirable that cuff 8 of gasket 30 be removed from flange 3 of gauge 1 when the gauge is to be operatively connected to a sanitary piping system. With tether 12 fitted about neck 2 of gauge 1, cuff 8 may be removed from flange 3 allowing the gasket to hang loose while the gauge is operatively connected to the sanitary piping system. With tether 12 remaining fitted to neck 2, gasket 30 is at hand ready to have its cuff 8 re-attached to flange 3 should it be necessary to remove the gauge from the piping system.

Perforations 15 of screen 14 provide a safeguard that will allow the gauge to register system pressure should the gauge be operatively connected to a sanitary piping system with cuff 8 still fitted to flange 3. To this end, the perforations of screen 14 are sufficiently numerous to allow the pressure of the process fluid in the sanitary piping system to actuate gauge diaphragm 6 with significant pressure loss.

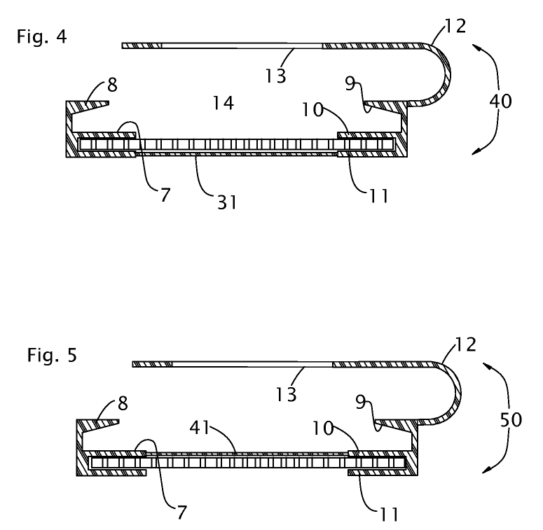

Referring to FIG. 4, a cross-sectional view of a first alternative embodiment of protective gasket 40 is shown which includes a thin membrane 31 of elastomeric material for isolating gauge 1 as well as screen 14 from process fluids. Membrane 31 also serves to safeguard the sanitary process against contamination should diaphragm 6 of gauge 1 rupture. In such an eventuality, membrane 31 isolates the operational fluids of gauge 1 from the sanitary piping system.

Referring to FIG. 5, a cross-sectional view of a second alternative embodiment of the invention in which screen 14 of gasket 50 is disposed to protect thin isolating membrane 41 of elastomeric material as well as the thin metallic diaphragm of gauge 1 from being inadvertently damaged.

What has been described is deemed to be illustrative of the principles of the invention. Further and other embodiments will be apparent to those skilled in the art.

1. An elastomeric gasket for protecting the sensing diaphragm of a sanitary piping system pressure gauge, the gasket comprising:
a retaining cuff and first and second flat ring portions, the gauge flange being fittable between the cuff and the first flat ring portion, the second flat ring portion being axially spaced apart from the first flat ring portion, and
a protective screen retained between the first and second flat ring disposed in front of the sensing diaphragm of the pressure gauge.

2. An elastomeric gasket according to claim 1 wherein the axial space between the first and second flat rings is with respect to the thickness of the protective screen is dimensioned to snugly retain the periphery of the protective screen therebetween.

3. An elastomeric gasket according to claim 2 wherein the protective screen has stiffness sufficient to resist bending into contact with the gauge diaphragm incident to ordinary handling.

4. An elastomeric gasket according to claim 1 having a thin membrane proceeding from either the first or second flat ring for isolating the gauge diaphragm from fluids of the sanitary piping system.

5. An elastomeric gasket according to claim 2 wherein either or both of said flat rings includes an O-ring bead.

6. An elastomeric gasket according to claim 4 wherein said screen is made of a metal inert to the process fluids of the sanitary piping system.

7. An elastomeric gasket according to claim 1 further comprising a tether proceeding from either the first or second flat ring, said tether having an aperture dimensioned to stretchably fit over the flange of said gauge to secure said cuff to said gauge when said cuff is not fitted to the flange of the gauge.

8. An elastomeric gasket according to claim 1 wherein said screen includes a plurality of apertures sufficient in total cross sectional area to transmit fluid pressure from the sanitary piping system to said gauge diaphragm when said gauge is connected to a fluid piping system with the cuff fitted to the gauge flange.
